(19) United States
(12) Patent Application Publication
(10) Pub. No.: US 2018/0066523 A1
(43) Pub. Date: Mar. 8, 2018

(54) TWO PRESSURE COOLING OF TURBINE AIRFOILS

(71) Applicant: Siemens Energy, Inc., Orlando, FL (US)

(72) Inventors: Jan H. Marsh, Orlando, FL (US); John J. Marra, Winter Springs, FL (US); Carmen Andrew Scribner, Fort Mill, SC (US)

(21) Appl. No.: 15/558,343

(22) PCT Filed: Apr. 6, 2015
(86) PCT No.: PCT/US15/24436

§ 371 Date: Sep. 14, 2017

(51) Int. Cl. F01D 5/18; F01D 25/12

(52) U.S. Cl. CPC F01D 5/186; F01D 25/12; F05D 2260/202; F05D 2220/32; F05D 2240/301; F01D 5/187

(57) ABSTRACT

An airfoil cooling system (54) for a gas turbine engine (10) is disclosed. The airfoil cooling system (54) may be formed from at least a first cooling fluid supply system (56), and a second cooling fluid supply system (58). The first cooling fluid supply system (56) may be configured to supply cooling fluids at a first pressure to one or more airfoils of a first row (68) of airfoils, and the second cooling fluid supply system (58) may be configured to supply cooling fluids at a second pressure to the one or more airfoils of the first row (68) of airfoils. Additionally, the second pressure may be lower than the first pressure. As such, each of the one or more airfoils may be cooled by cooling fluids at two different pressures. In particular embodiments, this may allow the airfoils to be cooled, while lowering the cost to the turbine engine (10) for providing such cooling.

### STATEMENT REGARDING FEDERALLY SPONSORED RESEARCH OR DEVELOPMENT

Development of this invention was supported in part by the United States Department of Energy, Advanced Hydrogen Turbine Development Program, Contract No. DE-FC26-05NT42644. Accordingly, the United States Government may have certain rights in this invention.

### FIELD OF THE INVENTION

This invention relates generally to gas turbine engines, and more particularly to cooling systems for turbine airfoils.

### BACKGROUND

Turbine engines commonly include airfoils (such as turbine blades and/or turbine vanes) positioned within the turbine section of the turbine engine. This positioning may subject the airfoils to temperatures that can cause heat-related damage or failure in the airfoils. As such, the airfoils are typically cooled by a cooling system that supplies cooling fluids into the interior of the airfoils. This typical airfoil cooling system, however, may be deficient and/or may be ready for improvement.

### SUMMARY OF THE INVENTION

An airfoil cooling system for a gas turbine engine is disclosed. The airfoil cooling system may be formed from at least a first cooling fluid supply system in fluid communication with a first portion of a compressor, and a second cooling fluid supply system in fluid communication with a second portion of the compressor. The first cooling fluid supply system may be configured to supply cooling fluids at a first pressure from the first portion of the compressor to one or more airfoils of a first row of airfoils arranged circumferentially around a rotor assembly of the gas turbine engine, and the second cooling fluid supply system may be configured to supply cooling fluids at a second pressure from the second portion of the compressor to the one or more airfoils of the first row of airfoils. Additionally, the second pressure may be lower than the first pressure. As such, each of the one or more airfoils may be cooled by cooling fluids at two different pressures. In particular embodiments, this may allow the airfoils to be cooled, while lowering the cost to the turbine engine for providing such cooling. For example, the cooling fluids at the second pressure may be less expensive to the turbine engine because they may undergo less compression at the compressor of the turbine engine. Additionally, this may further allow the airfoils to be more efficiently cooled, while still preventing hot gas ingestion into each of the airfoils. For example, an airfoil may include a pressure side cooling system, a suction side cooling system, and one or more chord-wise ribs (or other barrier) positioned in-between the pressure side cooling system and the suction side cooling system. Cooling fluids at the first pressure (which may be higher than the second pressure) may be supplied to the pressure side cooling system of the airfoil, thereby preventing the higher pressure fluids outside of the pressure side of the airfoil from being ingested into the airfoil, in particular embodiments. Additionally, cooling fluids at the second pressure (which may be lower than the first pressure) may be supplied to the suction side cooling system of the airfoil, in particular embodiments.

In at least one embodiment, a turbine engine may include a rotor assembly having a first row of airfoils arranged circumferentially around the rotor assembly. The turbine engine also includes a compressor positioned upstream from the rotor assembly, and a first cooling fluid supply system in fluid communication with a first portion of the compressor. The first cooling fluid supply system is configured to supply cooling fluids at a first pressure from the first portion of the compressor to a first airfoil of the first row of airfoils. The turbine engine further includes a second cooling fluid supply system in fluid communication with a second portion of the compressor. The second cooling fluid supply system is configured to supply cooling fluids at a second pressure from the second portion of the compressor to the first airfoil of the first row of airfoils. Additionally, the second pressure is lower than the first pressure.

The first cooling fluid supply system may be further configured to supply the cooling fluids at the first pressure from the first portion of the compressor to each airfoil of the first row of airfoils, and the second cooling fluid supply system may be further configured to supply the cooling fluids at the second pressure from the second portion of the compressor to each airfoil of the first row of airfoils. The first row of airfoils may include a first circumferentially aligned row of turbine blades extending radially outward from the rotor assembly. Furthermore, the first row of airfoils may include a first row of turbine vanes attached to a vane carrier arranged circumferentially around at least a portion of the rotor assembly. The turbine vanes of the first row of turbine vanes may each extend radially inward.

The turbine engine may further include a second row of airfoils arranged circumferentially around the rotor assembly, and a third cooling fluid supply system in fluid communication with a third portion of the compressor. The third cooling fluid supply system may be configured to supply cooling fluids at a third pressure from the third portion of the compressor to a first airfoil of the second row of airfoils. The third pressure may be lower than the second pressure. The second cooling fluid supply system may be further configured to supply cooling fluids at the second pressure from the second portion of the compressor to the first airfoil of the second row of airfoils. The first row of airfoils may include a first circumferentially aligned row of turbine blades extending radially outward from the rotor assembly, and the second row of airfoils may include a second circumferentially aligned row of turbine blades extending radially outward from the rotor assembly. The first row of airfoils may include a first row of turbine vanes attached to a vane carrier arranged circumferentially around at least a portion of the rotor assembly, and the second row of airfoils may include a first circumferentially aligned row of turbine blades extending radially outward from the rotor assembly. The turbine vanes of the first row of turbine vanes may each extend radially inward.

The turbine engine may further include a third row of airfoils arranged circumferentially around the rotor assembly. The third cooling fluid supply system may be further configured to supply cooling fluids at the third pressure from the third portion of the compressor to a first airfoil of the third row of airfoils. The turbine engine may further include a third row of airfoils arranged circumferentially around the rotor assembly, and a fourth cooling fluid supply system in fluid communication with a fourth portion of the compressor. The fourth cooling fluid supply system may be configured to supply cooling fluids at a fourth pressure from the fourth portion of the compressor to a first airfoil of the third row of airfoils. The fourth pressure may be lower than the third pressure. Furthermore, the third cooling fluid supply system may be further configured to supply cooling fluids at the third pressure from the third portion of the compressor to the first airfoil of the third row of airfoils.

The first airfoil of the first row of airfoils may include a pressure side cooling system, a suction side cooling system, and one or more chord-wise ribs positioned in-between the pressure side cooling system and the suction side cooling system. The first cooling fluid supply system may be further configured to supply cooling fluids at the first pressure from the first portion of the compressor to the pressure side cooling system of the first airfoil of the first row of airfoils. Additionally, the second cooling fluid supply system may be further configured to supply cooling fluids at the second pressure from the second portion of the compressor to the suction side cooling system of the first airfoil of the first row of airfoils.

The first airfoil of the first row of airfoils may include a pressure side cooling system, a suction side cooling system, and one or more chord-wise ribs positioned in-between the pressure side cooling system and the suction side cooling system, and the first airfoil of the second row of airfoils may include a pressure side cooling system, a suction side cooling system, and one or more chord-wise ribs positioned in-between the pressure side cooling system and the suction side cooling system. The first cooling fluid supply system may be further configured to supply cooling fluids at the first pressure from the first portion of the compressor to the pressure side cooling system of the first airfoil of the first row of airfoils. The second cooling fluid supply system may be further configured to supply cooling fluids at the second pressure from the second portion of the compressor to the suction side cooling system of the first airfoil of the first row of airfoils, and may be further configured to supply cooling fluids at the second pressure from the second portion of the compressor to the pressure side cooling system of the first airfoil of the second row of airfoils. Also, the third cooling fluid supply system may be further configured to supply cooling fluids at the third pressure from the third portion of the compressor to the suction side cooling system of the first airfoil of the second row of airfoils.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a cross-sectional view of a turbine engine with an example of an airfoil cooling system.

FIG. 2 is a perspective view of a turbine airfoil of the turbine engine in FIG. 1.

FIG. 3 is a cross-sectional view of the turbine airfoil shown in FIG. 2 taken at section line 3-3.

FIG. 4 is a slice view of both the rotating disc and a portion of the turbine airfoil of the turbine engine in FIG. 1 taken at detail 4-4, and includes a cross-sectional detail view of a root and an under root channel of the turbine engine in FIG. 1.

FIG. 5 is a cross-sectional detail view of the root and under root channel of the turbine engine taken at detail 5-5 of FIG. 4.

FIGS. 6-8 are cross-sectional views of under root channels and dividers of the turbine engine taken along section line 6-6 of FIG. 4.

### DETAILED DESCRIPTION OF THE INVENTION

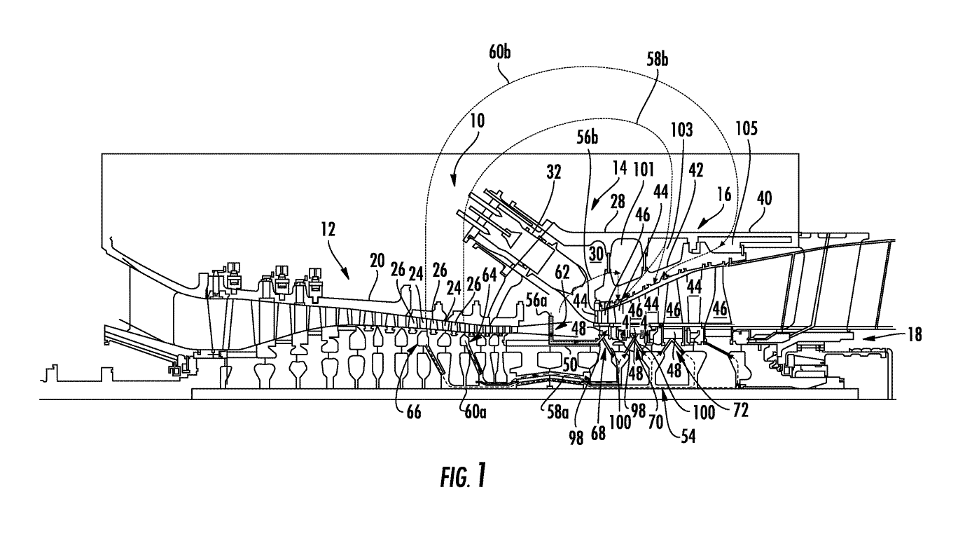

As shown in FIGS. 1-8, an airfoil cooling system 54 for a gas turbine engine 10 is disclosed. The airfoil cooling system 54 may be formed from at least a first cooling fluid supply system 56 in fluid communication with a first portion 62 of a compressor 12, and a second cooling fluid supply system 58 in fluid communication with a second portion 64 of the compressor 12. The first cooling fluid supply system 56 may be configured to supply cooling fluids at a first pressure from the first portion 62 of the compressor 12 to one or more airfoils of a first row of airfoils arranged circumferentially around a rotor assembly 18 of the gas turbine engine 10, and the second cooling fluid supply system 58 may be configured to supply cooling fluids at a second pressure from the second portion 64 of the compressor 12 to the one or more airfoils of the first row of airfoils. Additionally, the second pressure may be lower than the first pressure. As such, each of the one or more airfoils (such as each of one or more turbine blades 46 and/or stationary turbine vanes 44) may be cooled by cooling fluids at two different pressures. In particular embodiments, this may allow the airfoils to be cooled, while lowering the cost to the turbine engine for providing such cooling. For example, the cooling fluids at the second pressure may be less expensive to the turbine engine 10 because they may undergo less compression at the compressor 12 of the turbine engine 10. Additionally, this may further allow the airfoils to be more efficiently cooled, while still preventing hot gas ingestion into each of the airfoils. For example, an airfoil may include a pressure side cooling system 84, a suction side cooling system 86, and one or more barriers 88 positioned in-between the pressure side cooling system 84 and the suction side cooling system 86. Cooling fluids at the first pressure (which may be higher than the second pressure) may be supplied to the pressure side cooling system 84 of the airfoil, thereby preventing the higher pressure fluids outside of the pressure side 76 of the airfoil from being ingested into the airfoil, in particular embodiments. Additionally, cooling fluids at the second pressure (which may be lower than the first pressure) may be supplied to the suction side cooling system 86 of the airfoil, thereby preventing the lower pressure fluids outside of the suction side 78 of the airfoil from being ingested into the airfoil, in particular embodiments.

As is further shown in FIGS. 1-8, an airfoil cooling system 54 for a gas turbine engine 10 is disclosed. The airfoil cooling system 54 may be formed from at least a first cooling fluid supply system 56 in fluid communication with a first portion 62 of a compressor 12, and a second cooling fluid supply system 58 in fluid communication with a second portion 64 of the compressor 12. The first cooling fluid supply system 56 may include a first supply channel 98 that supplies cooling fluids to a first cooling system 84 of each of two or more airfoils in the same row of airfoils. The second cooling fluid supply system 58 may include a first supply channel 100 that supplies cooling fluids to a second cooling system 86 of each of the same two or more airfoils. As such, two or more airfoils (such as two or more turbine blades 46 or two or more stationary turbine vanes 44) may receive cooling fluids from two different supply channels 98 and 100. In particular embodiments, this may allow the two or more airfoils to be cooled by cooling fluids at two different pressures (or by cooling fluids received from two different portions of the compressor 12). Additionally, the two or more airfoils (such as two or more turbine blades 46) may receive the cooling fluids via under-root channels 102 and connection channels 106 and 108 that connect directly and/or indirectly to the two supply channels 98 and 100. In particular embodiments, this may reduce the number of supply channels 98 and 100 formed in a rotating disc 48 (or other support structure) of the turbine engine 10, thereby increasing the integrity of the rotating disc 48 and/or reducing the cost to produce the rotating disc 48.

As shown in FIG. 1, the turbine engine 10 may include a compressor section 12, a combustor section 14, and the turbine section 16. A rotor assembly 18 is centrally located and extends through the three sections. The compressor section 12 may include cylinder 20 that encloses alternating rows of airfoils, such as stationary vanes 24 and rotating blades 26. The stationary vanes 24 may be affixed to the cylinder 20 while the rotating blades 26 may be mounted to the rotor assembly 18 for rotation with the rotor assembly 18.

The combustion section 14 may include a shell 28 that forms a chamber 30. Multiple combustors, for example, sixteen combustors (only one combustor 32 of which is shown) may be contained within the combustion section chamber 30 and distributed around a circle in an annular pattern. Fuel, which may be in liquid or gaseous form—such as oil or gas—may enter each combustor 32 and be combined with compressed air introduced into the combustor 32 from the chamber 30. The combined fuel/air mixture may be burned in the combustor 32 and the resulting hot, compressed gas flow may be exhausted to a transition duct (not shown) attached to the combustor 32 for routing to the turbine section 16.

The turbine section 16 may include a cylindrical housing 40, including an inner cylinder 42, which may enclose rows of airfoils (such as stationary turbine vanes 44 and/or rotating turbine blades 46) arranged circumferentially around the rotor assembly 18. The first row of vanes 44 and the first row of blades 46 near the entry of the turbine section 16 are generally referred to as the first stage vanes and the first stage blades, respectively. Each row of blades 46 may be formed by a plurality of airfoils attached to a disc 48 provided on a rotor 50 to form the rotor assembly 18. The blades 46 may extend radially outward from the discs 48 and terminate in a region known as the blade tip. Each row of vanes 44 may be formed by attaching one or more vanes 44 to a turbine engine support structure, such as, but not limited to, the inner cylinder 42, which may also be referred to as a vane carrier, turbine shroud support (hooks), ring segment support (hooks) and blade outer air seal support (hooks). The vanes 44 may extend radially inward from an inner portion of the inner cylinder 42 and terminate proximate to the rotor 50. The inner cylinder 42 may be attached to the cylindrical housing 40, which may enclose the turbine section 16 of the engine 10.

For a better understanding of the invention, a coordinate system can be applied to such a turbine engine 10 to assist in the description of the relative location of components in the system and movement within the system. The axis of rotation of the rotor assembly 18 extends longitudinally through the compressor section 12, the combustion section 14 and the turbine section 16 and defines a longitudinal direction. Viewed from the perspective of the general operational flow pattern through the various sections, the turbine components can be described as being located longitudinally upstream or downstream relative to each other. For example, the compressor section 12 is longitudinally upstream of the combustor section 14 and the turbine section 16 is longitudinally downstream of the combustor section 14. The location of the various components away from the central rotor axis or other longitudinal axis can be described in a radial direction. Thus, for example, the blade 46 extends in a radial direction, or radially, from the disc 48. Locations further away from a longitudinal axis, as well as the central rotor axis, can be described as radially outward or outboard compared to closer locations that are radially inward or inboard. The third coordinate direction—a circumferential direction—can describe the location of a particular component with reference to an imaginary circle around a longitudinal axis, such as the central axis of the rotor assembly 18. For example, looking longitudinally downstream at an array of turbine blades in a turbine engine, one would see each of the blades extending radially outwardly in several radial directions like hands on a clock. The “clock” position—also referred to as the angular position—of each blade describes its location in the circumferential direction. Thus, a blade in this example extending vertically from the rotor disc 48 can be described as being located at the “12 o'clock” position in the circumferential direction while a blade extending to the right from the rotor disc 48 can be described as being located at the “3 o'clock” position in the circumferential direction (when viewing the blade from an longitudinally upstream position), and these two blades can be described as being spaced apart in the circumferential direction. Thus, the radial direction can describe the size of the reference circle and the circumferential direction can describe the angular location on the reference circle.

As shown in FIG. 1, the turbine engine 10 may further include an airfoil cooling system 54. The airfoil cooling system 54 may provide cooling fluids to blades 46 of the turbine section 16, to vanes 44 of the turbine section 16, or to both blades 46 and vanes 44 of the turbine section 16. Airfoil cooling system 54 may include cooling fluid supply systems 56, 58, and 60. Each of the cooling fluid supply systems 56, 58, and 60 may be in fluid communication with a portion of the compressor section 12. Furthermore, none of the cooling fluid supply systems 56, 58, and 60 may be in fluid communication with each other.

First cooling fluid supply system 56 (such as first cooling fluid supply system 56a and/or first cooling fluid supply system 56b) may be in fluid communication with the compressor section 12 at, for example, a portion 62 that is downstream of all of the vanes 24 and 26. That is, first cooling fluid supply system 56 may receive cooling fluids that have passed entirely through the compressor section 12, thereby causing the cooling fluids to have a higher pressure than if they had not passed entirely through compressor section 12. Furthermore, because the cooling fluids received by first cooling fluid supply system 56 have passed entirely through the compressor section 12, these cooling fluids received at first cooling fluid supply system 56 may be expensive to produce by the turbine engine 10.

Second cooling fluid supply system 58 (such as second cooling fluid supply system 58a and/or second cooling fluid supply system 58b) may be in fluid communication with the compressor section 12 at, for example, a portion 64 that is upstream of the portion 62. An example of portion 64 may be a portion that is located at the tenth stage (e.g., the tenth row of blades 26 of the compressor section 12). That is, in such an example, second cooling fluid supply system 58 may receive cooling fluids that have passed through ten rows of blades 26, but have not passed through the remaining blades 26 downstream of portion 64. As a result of not passing through all of the blades 26 (such as may occur with the cooling fluids received by first cooling fluid supply system 56), the cooling fluids received by second cooling fluid supply system 58 may have a lower pressure than the cooling fluids received by first cooling fluid supply system 56. Similarly, the cooling fluids received by second cooling fluid supply system 58 may be less expensive to produce by turbine engine 10 than those received by first cooling fluid supply system 56. Furthermore, as a result of not passing through all of the blades 26 (such as may occur with the cooling fluids received by first cooling fluid supply system 56), the cooling fluids received by second cooling fluid supply system 58 may also have a lower temperature than the cooling fluids received by first cooling fluid supply system 56. As such, the cooling fluids received by the second cooling fluid supply system 58 may more effectively cool the airfoils of the turbine engine 10.

Third cooling fluid supply system 60 (such as third cooling fluid supply system 60a and/or third cooling fluid supply system 60b) may be in fluid communication with the compressor section 12 at, for example, a portion 66 that is upstream of the portion 64. An example of portion 66 may be a portion that is located at the eighth stage (e.g., the eighth row of blades 26 of the compressor section 12). That is, in such an example, third cooling fluid supply system 60 may receive cooling fluids that have passed through eight rows of blades 26, but have not passed through the remaining blades 26 downstream of portion 66. As a result of not passing through as many blades 26, the cooling fluids received by third cooling fluid supply system 60 may have a lower pressure than the cooling fluids received by second cooling fluid supply system 58. Similarly, the cooling fluids received by third cooling fluid supply system 60 may be less expensive to produce by turbine engine 10 than those received by second cooling fluid supply system 58. Furthermore, as a result of not passing through as many blades 26, the cooling fluids received by third cooling fluid supply system 60 may have a lower temperature than the cooling fluids received by second cooling fluid supply system 58. As such, the cooling fluids received by the third cooling fluid supply system 60 may more effectively cool the airfoils of the turbine engine 10.

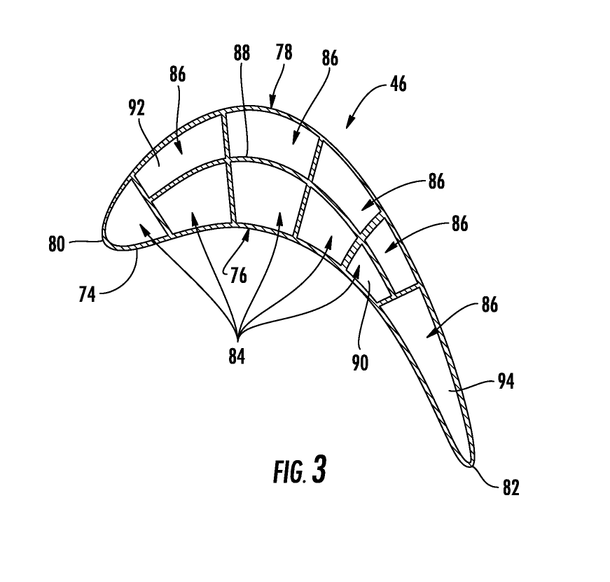

In addition to being in fluid communication with portions of the compressor section 12, each of fluid cooling supply systems 56, 58, and 60 may supply cooling fluids from the respective portion of the compressor section 12 to one or more airfoils (such as one or more blades 46 via fluid cooling supply systems 56a, 58a, and 60a and/or vanes 44 via fluid cooling supply systems 56b, 58b, and 60b) of the turbine section 16. For example, first cooling fluid supply system 56 may supply cooling fluids to one or more airfoils of a first row 68 of airfoils. In such an example, if the first row 68 of airfoils is a row of blades 46, first cooling fluid supply system 56a may supply cooling fluids to one or more blades 46 (or all of the blades 46) of the first row 68 of blades 46. Furthermore, if the first row 68 of airfoils is a row of vanes 44, first cooling fluid supply system 56b may supply cooling fluids to one or more vanes 44 (or all of the vanes) of the first row 68 of vanes 44 (via one or more first pressure cavities 101). Additionally, the cooling fluids from first cooling fluid supply system 56 may be supplied to a portion of an airfoil of the first row 68 of airfoils. For example, as is discussed below with regard to FIG. 3, the cooling fluids from first cooling fluid supply system 56 may be supplied to a pressure side cooling system 84 of an airfoil.

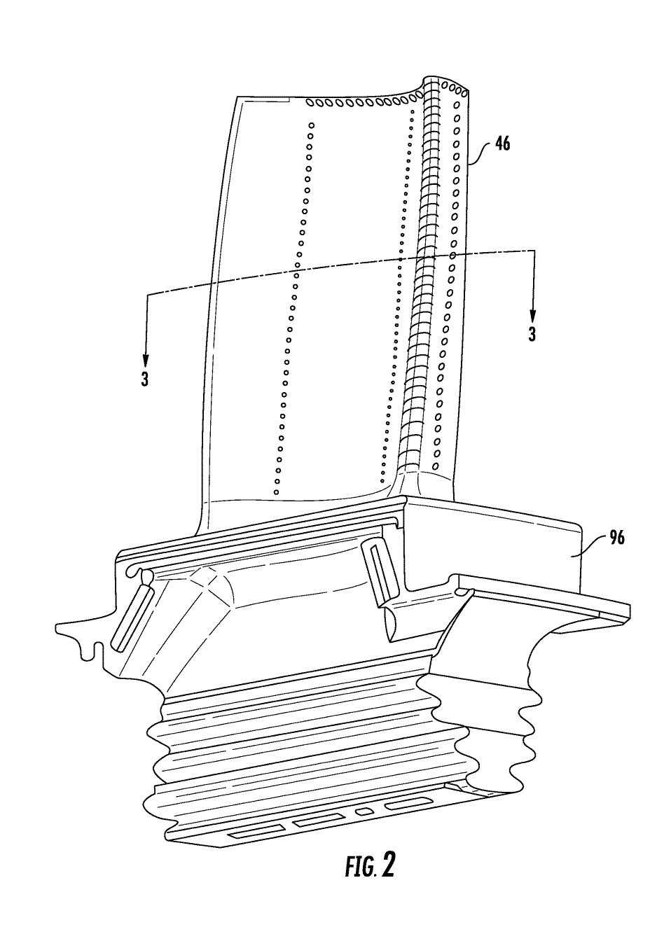

Second cooling fluid supply system 58 may supply fluids to the same airfoils supplied by first cooling fluid supply system 56. For example, if the first row 68 of airfoils is a row of blades 46, second cooling fluid supply system 58a may supply cooling fluids to the same one or more blades 46 (or all of the blades 46) of the first row 68 of blades 46 supplied by first cooling fluid supply system 56a. Furthermore, if the first row 68 of airfoils is a row of vanes 44, second cooling fluid supply system 58b may supply cooling fluids to the same one or more vanes 44 (or all of the vanes) of the first row 68 of vanes 44 supplied by first cooling fluid supply system 56b (via one or more second pressure cavities 103). Additionally, the cooling fluids from second cooling fluid supply system 58 may be supplied to a portion of an airfoil of the first row 68 of airfoils. For example, as is discussed below with regard to FIG. 2, the cooling fluids from second cooling fluid supply system 58 may be supplied to a suction side cooling system 86 of an airfoil.

As a result of cooling fluid supply systems 56 and 58, the same airfoils may receive cooling fluids at two different pressures, in particular embodiments. This cooling of the airfoils of turbine engine 10 may differ from conventional cooling techniques where a row of airfoils, such as a first row of turbine blades, is cooled by cooling fluids having the same pressure and/or that is supplied by the same portion of the compressor section. As an example, in conventional cooling techniques, the first row of airfoils may be cooled by cooling fluids supplied only from a single portion of a gas turbine engine (such as only portion 62). This conventional cooling of the airfoils may be more costly to the turbine engine because all of these cooling fluids pass through all of the vanes and blades of the compressor section. In contrast, in particular embodiments, the first row 68 of airfoils of gas turbine engine 10 may be cooled by cooling fluids supplied by first cooling fluid supply system 56 and second cooling fluid supply system 58. Thus, the first row 68 of airfoils may be cooled (at least partially) by cooling fluids received from portion 64 of the compressor section 12, which is less costly to the gas turbine engine 10 than the cooling fluids from portion 62 of the compressor section 12.

Second cooling fluid supply system 58 may also supply cooling fluids to one or more airfoils of a second row 70 of airfoils. In such an example, if the second row 70 of airfoils is a row of blades 46, second cooling fluid supply system 58a may supply cooling fluids to one or more blades 46 (or all of the blades 46) of the second row 70 of blades 46. Furthermore, if the second row 70 of airfoils is a row of vanes 44, second cooling fluid supply system 58b may supply cooling fluids to one or more vanes 44 (or all of the vanes) of the second row 70 of vanes 44 (via one or more second pressure cavities 103). Additionally, the cooling fluids from second cooling fluid supply system 58 may be supplied to a portion of an airfoil of the second row 70 of airfoils. For example, as is discussed below with regard to FIG. 2, the cooling fluids from second cooling fluid supply system 58 may be supplied to a pressure side cooling system 84 of an airfoil.

Third cooling fluid supply system 60 may supply cooling fluids to the same airfoils of the second row 70 of airfoils supplied by second cooling fluid supply system 58. For example, if the second row 70 of airfoils is a row of blades 46, third cooling fluid supply system 60a may supply cooling fluids to the same one or more blades 46 (or all of the blades 46) of the second row 70 of blades 46 supplied by second cooling fluid supply system 58a. Furthermore, if the second row 70 of airfoils is a row of vanes 44, third cooling fluid supply system 60b may supply cooling fluids to the same one or more vanes 44 (or all of the vanes) of the second row 70 of vanes 44 supplied by second cooling fluid supply system 58b (via one or more third pressure cavities 105). Additionally, the cooling fluids from third cooling fluid supply system 60 may be supplied to a portion of an airfoil of the second row 70 of airfoils. For example, as is discussed below with regard to FIG. 3, the cooling fluids from third cooling fluid supply system 60 may be supplied to a suction side cooling system 86 of an airfoil.

As a result of cooling fluid supply systems 58 and 60, the same airfoils of the second row 70 of airfoils may receive cooling fluids at two different pressures, in particular embodiments. Thus, the second row 70 of airfoils may be cooled (at least partially) by cooling fluids received from portion 66 of the compressor section 12, which is less costly to the gas turbine engine 10 than the cooling fluids from portion 64 of the compressor section 12.

Third cooling fluid supply system 60 may also supply cooling fluids to one or more airfoils of a third row 72 of airfoils. In such an example, if the third row 72 of airfoils is a row of blades 46, third cooling fluid supply system 60a may supply cooling fluids to one or more blades 46 (or all of the blades 46) of the third row 72 of blades 46. Furthermore, if the third row 72 of airfoils is a row of vanes 44, third cooling fluid supply system 60b may supply cooling fluids to one or more vanes 44 (or all of the vanes 44) of the third row 72 of vanes 44 (via one or more third pressure cavities 105). As illustrated in FIG. 1, the third row 72 of airfoils may receive cooling fluids from only the third fluid cooling system 60. That is, contrary to the first row 68 and the second row 70 of airfoils, the third row 72 of airfoils may not receive cooling fluids at different pressures. However, in particular embodiments, the third row 72 may receive cooling fluids at different pressures. For example, in addition to the cooling supplied by the third cooling fluid supply system 60, the turbine engine 10 may include a fourth cooling fluid supply system (not shown) that may be in fluid communication with a fourth portion (not shown, but which may be positioned upstream of portion 66 and may supply cooling fluids at a lower pressure than those supplied by portion 66) of compressor section 12 and may supply cooling fluids from the fourth portion to the same airfoils of the third row 72 of airfoils supplied by third cooling fluid supply system 72. As a result of third cooling fluid supply system 60 and the fourth cooling supply system, the same airfoils of the third row 72 of airfoils may receive cooling fluids at two different pressures, in particular embodiments. Thus, the third row 72 of airfoils may be cooled (at least partially) by cooling fluids received from the fourth portion of the compressor section 12, which is less costly to the gas turbine engine 10 than the cooling fluids from portion 66 of the compressor section 12.

Although the turbine engine 10 of FIG. 1 has been illustrated as providing cooling fluids to three rows of airfoils, the cooling described above may be applied to more or fewer airfoils of turbine engine 10. For example, the cooling described above may be applied to all of the airfoils of the turbine section 16 (or all stages of the turbine section 16). As another example, the cooling described above may be applied to any other number of airfoils of the turbine section 16 (or any number of stages of the turbine section 16). Additionally, although the turbine engine 10 of FIG. 1 has been illustrated as including three cooling fluid supply systems (i.e., first cooling fluid supply system 56, second cooling fluid supply system 58, and third cooling fluid supply system 60), the turbine engine 10 may have any number of cooling fluid supply systems. For example, the turbine engine 10 may have a different cooling fluid supply system in fluid communication with each stage of the compressor section 12.

Furthermore, although the turbine engine 10 of FIG. 1 has been illustrated as including three cooling fluid supply systems (i.e., first cooling fluid supply system 56, second cooling fluid supply system 58, and third cooling fluid supply system 60) in fluid communication with particular portions of compressor section 12, each cooling fluid supply system 56, 58, and 60 (and/or any other cooling fluid supply system) may be in fluid communication with any other portions of compressor section 12. For example, first cooling fluid supply system 56 may be in fluid communication with the thirteenth stage of the compressor section 12, second cooling fluid supply system 58 may be in fluid communication with the eleventh stage of the compressor section 12, and third cooling fluid supply system 60 may be in fluid communication with the ninth stage of the compressor section 12. Additionally, although the turbine engine 10 of FIG. 1 has been illustrated as including three cooling fluid supply systems (i.e., first cooling fluid supply system 56, second cooling fluid supply system 58, and third cooling fluid supply system 60) supplying cooling fluids to particular rows of airfoils, each cooling fluid supply system 56, 58, and 60 (and/or any other cooling fluid supply system) may supply cooling fluids to any row of airfoils in the turbine section 16. For example, first cooling fluid supply system 56 may supply cooling fluids to the second row 70 of airfoils (or to both the first row 68 and the second row 70 of airfoils), second cooling fluid supply system 58 may supply cooling fluids to the second row 70 and the third row 72 of airfoils, and third cooling fluid supply system 60 may supply cooling fluids to the third row 72 and a fourth row of airfoils.

FIG. 2 is a perspective view of a turbine airfoil of the turbine engine in FIG. 1. The airfoil may be a turbine blade 46 or a turbine vane 44. As illustrated, the airfoil is a turbine blade 46. The airfoil may be formed from a generally elongated blade portion coupled to a root 96. FIG. 3 is a cross-sectional view of the turbine airfoil shown in FIG. 2 taken at section line 3-3. As illustrated, the airfoil is a turbine blade 46. Blade 46 may have an outer wall 74 adapted for use, for example, in a first row 68 of airfoils of the turbine section 16, the second row 70 of airfoils of the turbine section 16, the third row 72 of airfoils of the turbine section 16, or any other row of airfoils of the turbine section 16. Outer wall 74 may form a generally concave shaped portion forming pressure side 76 and may form a generally convex shaped portion forming suction side 78. The pressure side cooling system 84 and suction side cooling system 86 may be positioned in inner aspects of the blade 46 for directing one or more cooling fluids through the blade 46 and out one or more exhaust orifices (not shown) in the blade 46 to reduce the temperature of the blade 46. The exhaust orifices may be positioned anywhere on pressure side 76 and suction side 78, and may have various configurations.

As shown in FIG. 3, the airfoil may include the pressure side cooling system 84 and the suction side cooling system 86 separated by one or more barriers 88 positioned in-between the pressure side cooling system 84 and the suction side cooling system 86. A barrier 88 may be any element that separates the pressure side cooling system 84 from the suction side cooling system 86, such as a chord-wise rib, a blocker, an impingement insert, any other element, or any combination of the preceding. The pressure side cooling system 84 may be formed by one or more channels. For example, as illustrated, the pressure side cooling system 84 may be formed by a five pass serpentine channel. In further embodiments, the pressure side cooling system 84 may be formed by a three pass serpentine channel, or any other configuration of one or more channels (such as channels that utilize impingement cooling configurations, as may be the case with vanes 44). The pressure side cooling system 84 may include an inlet 90 proximate to the root 96 for receiving cooling fluids from a cooling fluid supply system, such as first cooling fluid supply system 56, second cooling fluid supply system 58, third cooling fluid supply system 60, or any other cooling fluid supply system. Furthermore, as illustrated, the cooling fluids may flow from the trailing edge 82 to the leading edge 80, and exit the blade 46 out the exhaust orifices located near the leading edge 80. In particular embodiments, pressure side cooling system 84 may receive cooling fluids at inlet 90 from first cooling fluid supply system 56 of FIG. 1. In such an example, the higher pressure of the cooling fluids received from portion 62 of the compressor section 12 may counteract the higher pressure of fluids outside of the blade 46 on the pressure side 76, thereby preventing the outside fluids from being ingested into the blade 46 via the exhaust orifices.

The suction side cooling system 86 may be formed by one or more channels. For example, as illustrated, the suction side cooling system 86 may be formed by a four pass serpentine channel. In further embodiments, the pressure side cooling system 84 may be formed by a three pass serpentine channel, a two pass serpentine channel, or any other configuration of one or more channels (such as channels that utilize impingement cooling configurations, as may be the case with vanes 44). The pressure side cooling system 84 may include inlets 92 and 94 proximate to the root 96 for receiving cooling fluids from a cooling fluid supply system, such as first cooling fluid supply system 56, second cooling fluid supply system 58, third cooling fluid supply system 60, or any other cooling fluid supply system. Furthermore, as illustrated, the cooling fluids received at inlet 92 may flow from the leading edge 80 to the trailing edge 82, and exit the blade 46 out the exhaust orifices located near the trailing edge 82. In particular embodiments, suction side cooling system 86 may receive cooling fluids at inlets 92 and 94 from second cooling fluid supply system 58 of FIG. 1. In such an example, the lower pressure of the cooling fluids received from portion 64 (in comparison to the higher pressure of the cooling fluids received from portion 62) may counteract the lower pressure of fluids outside of the blade 46 on the suction side 78 (in comparison to the higher pressure of fluids outside of the blade 46 on the pressure side 76), thereby preventing the outside fluids from being ingested into the blade 46 via the exhaust orifices. This cooling of the airfoils of turbine engine 10 may differ from conventional cooling techniques where an airfoil was provided with cooling fluids at the same pressure at both the pressure side and the suction side of the airfoil. In such conventional techniques, the pressure of the cooling fluid was required to be high enough to counteract the higher pressure of fluids outside of the airfoil on the pressure side, even when those cooling fluids were used to cool the suction side (which is subject to lesser pressure outside of the airfoil). As such, these conventional cooling techniques required the turbine engine 10 to provide costly high pressure cooling fluids to portions of the airfoil that did not require such a high pressure. In contrast, in particular embodiments, the pressure side cooling system 84 of an airfoil (such as blade 46) is provided with higher pressure cooling fluids (so as to counteract the higher pressures outside of the airfoil on the pressure side 76), while the suction side cooling system 86 of the airfoil (such as blade 46) is provided with lower pressure cooling fluids (so as to counteract the lower pressures outside of the airfoil on the suction side 78). In particular embodiments, this may allow the airfoil to be cooled in a more efficient manner, but still prevent hot gas ingestion into the airfoil.

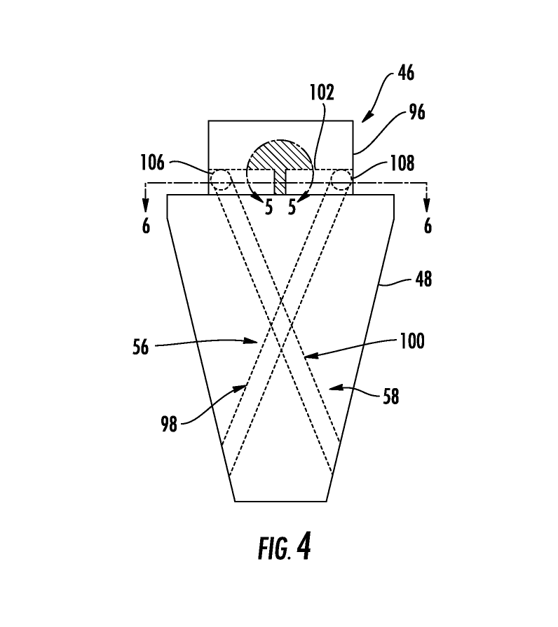

FIG. 4 is a slice view of both the rotating disc and a portion of the turbine airfoil of the turbine engine in FIG. 1 taken at detail 4-4, and includes a cross-sectional detail view of a root and an under root channel of the turbine engine in FIG. 1. As is explained above, a row of turbine blades 46 may be formed by a plurality of airfoils attached to the rotating disc 48. Each of the turbine blades 46 of the row of turbine blades 46 includes a blade portion (not shown) and a root 96. The root 96 of the blade 46 is attached to the disc 48 provided on the rotor 50 of the rotor assembly 18. As such, the blade 46 extends radially outward from the disc 48.

In order to supply cooling fluids to airfoils (such as blades 46), the cooling fluid supply systems 56, 58, and 60 of FIG. 1 may be positioned inside of discs 48 (or inside other support structures, as may be the case for vanes 44). For example, first and second cooling fluid supply systems 56 and 58 may be positioned inside of disc 48 of the first row 68 of blades 46; second and third cooling fluid supply systems 58 and 60 may be positioned inside of disc 48 of the second row 70 of blades 46; and third cooling fluid supply system 60 (or third and fourth cooling fluid supply systems) may be positioned inside of disc 48 of the third row 72 of blades 46. The cooling fluid supply systems may be positioned inside of discs 48 in any suitable manner. For example, one or more supply channels 98 and 100 of the cooling fluid supply systems may be drilled, machined, or otherwise formed in discs 48. The supply channels 98 and 100 may be formed in any configuration in the disc 48. As an example, supply channels 98 and 100 may be formed at any angle that causes them to cross each other at a particular point (as illustrated in FIGS. 1 and 4). In such an example, the supply channels 98 and 100 may be circumferentially spaced from each other, thereby preventing supply channel 98 from physically intersecting with supply channel 100. As another example, supply channels 98 and 100 may be formed at any angle that does not cause supply channels 98 and 100 to cross each other. In such an example, supply channels 98 and 100 may not be circumferentially spaced from each other (or they may still be circumferentially spaced from each other).

Supply channels 98 and 100 may be a portion of any of the cooling fluid supply systems of FIG. 1. As illustrated in FIG. 4, supply channels 98 are a portion of first cooling fluid supply system 56 and supply channels 100 are a portion of second cooling fluid supply system 58, for example. As such, in particular embodiments, supply channels 98 may supply cooling fluids from portion 62 (e.g., having a higher pressure) to one or more blades 46 of the row of blades 46 attached to disc 48, and supply channels 100 may supply cooling fluids from portion 64 (e.g., having a lower pressure than that supplied by portion 62) to one or more blades 46 of the row of blades 46 attached to disc 48.

Supply channels 98 and 100 may supply cooling fluids to any number of blades 46 of the row of blades 46. For example, each supply channel 98 and each supply channel 100 may only supply cooling fluids to a single blade 46 of the row of blades 46. In such an example, disc 48 may include a supply channel 98 and a supply channel 100 for each blade 46 in the row of blades 46. Therefore, if there are twelve blades 46 in the row of blades 46, disc 48 may include twelve supply channels 98 and twelve supply channels 100, for a total of 24 supply channels. As another example, each supply channel 98 and each supply channel 100 may supply cooling fluids to a set of two blades 46 of the row of blades 46. In such an example, disc 48 may include a supply channel 98 and a supply channel 100 for each set of two blades 46 in the row of blades 46. Therefore, if there are twelve blades 46 in the row of blades 46, disc 48 may include six supply channels 98 and six supply channels 100, for a total of twelve supply channels. In particular embodiments, this may increase the structural integrity of disc 48, as it may reduce the number of supply channels 98 and 100 that are formed in disc 48. Furthermore, in particular embodiments, this may decrease the cost to produce the disc 48, as fewer supply channels 98 and 100 may be formed in disc 48.

As a further example, each supply channel 98 and each supply channel 100 may supply cooling fluids to a set of three or more blades 46 of the row of blades 46. In such an example, disc 48 may include a supply channel 98 and a supply channel 100 for each set of three or more blades 46 in the row of blades 46. Therefore, if there are twelve blades 46 in the row of blades 46, disc 48 may include four or less supply channels 98 and four or less supply channels 100, for a total of eight or less supply channels 98 and 100. In particular embodiments, this may further increase the structural integrity of disc 48, as it may further reduce the number of supply channels 98 and 100 that are formed in disc 48. Furthermore, in particular embodiments, this may further decrease the cost to produce the disc 48, as fewer supply channels 98 and 100 may be formed in disc 48.

Supply channels 98 and 100 may each supply cooling fluids to particular portions of one or more blades 46. For example, supply channels 98 may supply cooling fluids to a pressure side cooling system 84 (shown in FIG. 3) of the blades 46 and supply channels 100 may supply cooling fluids to a suction side cooling system 86 (also shown in FIG. 3) of the blades 46. As such, when each supply channel 98 and each supply channel 100 only supplies cooling fluids to a single blade 46 of the row of blades 46 (as discussed above), the supply channel 98 may only supply cooling fluids to the pressure side cooling system 84 of the single blade 46, and the supply channel 100 may only supply cooling fluids to the suction side cooling system 86 of the single blade 46. Similarly, when each supply channel 98 and each supply channel 100 supplies cooling fluids to a set of two or more blades 46 of the row of blades 46 (as is also discussed above), the supply channel 98 may only supply cooling fluids to the pressure side cooling systems 84 of the set of two or more blades 46, and the supply channel 100 may only supply cooling fluids to the suction side cooling system 86 of the set of two or more blades 46.

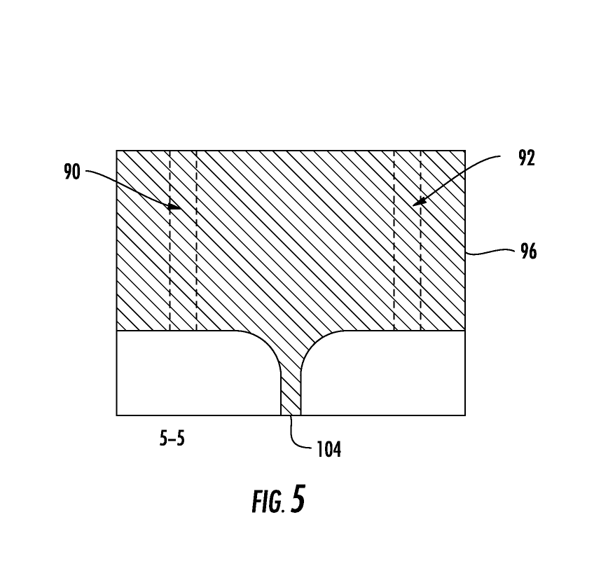

As is further illustrated in FIGS. 4-5, each of the plurality of turbine blades 46 of the row of turbine blades 46 is in fluid communication with an under-root channel 102. The under-root channel 102 may receive cooling fluids directly or indirectly from supply channels 98 and 100, and may further supply the cooling fluids to the blade 46. As illustrated, under-root channel 102 may supply cooling fluids from supply channel 98 (e.g., with a higher pressure) to the blade 46 via inlet 90, and may further supply cooling fluids from supply channel 100 (e.g., with a lower pressure) to the blade 46 via inlet 92 and inlet 94 (not shown). The under-root channel 102 may be located radially underneath the root 96 of blade 46. In such an example, a portion of the root 96 may extend radially downward into the under-root channel to act as a divider 104 (shown in FIG. 5, which is a cross-sectional detail view of a root and an under root channel of the turbine engine taken at detail 5-5 of FIG. 4) between the cooling fluids supplied by supply channel 98 and supply channel 100. Alternatively (or additionally), a portion of the disc 48 may extend radially outward into the under-root channel to act as the divider 104 between the cooling fluids supplied by supply channel 98 and supply channel 100. As a result of divider 104, the cooling fluids supplied by supply channel 98 (which may have a higher pressure) may not be in fluid communication with the cooling fluids supplied by supply channel 100 (which may have a lower pressure than those supplied by supply channel 98). The under-root channel 102 may also be located in root 96, adjacent root 96 (such as on the side of root 96), or at any other position that may allow under-root channel 102 to receive cooling fluids directly or indirectly from supply channels 98 and 100, and to further supply the cooling fluids to the blade 46.

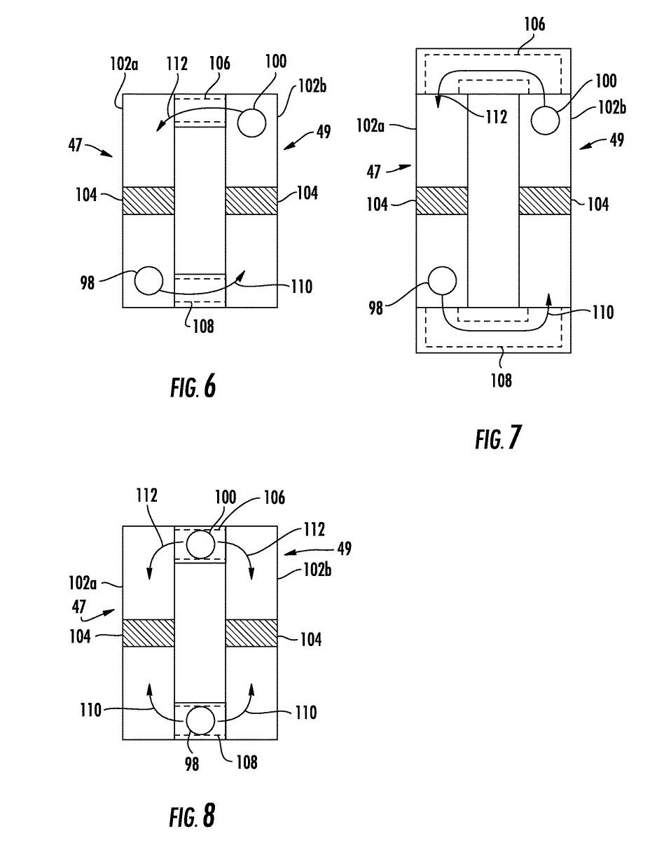

Under-root channel 102 of a blade 46 may further be in fluid communication with one or more connection channels 106 and 108 (shown in FIG. 4) that may provide fluid communication between the under-root channel 102 of the blade 46 and the under-root channel 102 of one or more additional blades 46 in the row of blades 46. As is discussed above, each supply channel 98 and each supply channel 100 may supply cooling fluids to a set of two or more blades 46 of the row of blades 46, thereby reducing the number of supply channels formed in a disc 48. In particular embodiments, connection channels 106 and 108 may allow the cooling fluids to be communicated between the blades 46 in a set of two or more blades 46. For example, cooling fluids may be supplied by supply channel 98 directly to under-root channel 102 of a first blade 47 in a set of two or more blades 46. In addition to the cooling fluids being supplied to the first blade 47, a portion of the cooling fluids may be supplied through connection channel 106 (for example) to the under-root channel 102 of a second blade 49 (and/or to any other blade 46) of the set of two or more blades 46. As such, a single supply channel 98 (and a single supply channel 100) may supply cooling fluids to more than one blade 46. Additional examples are discussed below with regard to FIGS. 6-8.

FIGS. 6-8 are cross-sectional views of under root channels and dividers of the turbine engine taken along section line 6-6 of FIG. 4. Additionally, FIGS. 6-8 illustrate various examples of fluid communication between airfoils of a turbine engine 10. A first airfoil (such as a first blade 47, which is not expressly illustrated in FIGS. 6-8) may be in fluid communication with an under-root channel 102a and a second airfoil (such as a second blade 49, which is not expressly illustrated in FIGS. 6-8) may also be in fluid communication an under-root channel 102b. Under-root channel 102a of the first blade 47 may be attached to and in fluid communication with supply channel 98. As such, cooling fluids from, for example, first cooling fluid supply system 56 (and portion 62) may be received by the under-root channel 102a of the first blade 47 and supplied to, for example, pressure side cooling system 84 of the first blade 47. Furthermore, a connection channel 108 may be positioned in-between the under-root channel 102a of the first blade 47 and the under-root channel 102b of the second blade 49, connecting the under-root channel 102a of the first blade 47 to the under-root channel 102b of the second blade 49. As such, cooling fluids from supply channel 98 may be supplied to the under-root channel 102b of the second blade 49 (as is illustrated by arrow 110) via connection channel 108 and under-root channel 102a of the first blade 47. Furthermore, the cooling fluids may also be supplied to, for example, the pressure side cooling system 84 of the second blade 49.

Additionally, the under-root channel 102b of the second blade 49 may be attached to and in fluid communication with supply channel 100. As such, cooling fluids from, for example, cooling fluid supply system 58 (and portion 64) may be received by the under-root channel 102b of the second blade 49 and supplied to, for example, suction side cooling system 86 of the second blade 49. Furthermore, a connection channel 106 may be positioned in-between the under-root channel 102b of the second blade 49 and the under-root channel 102a of the first blade 47, connecting the under-root channel 102b of the second blade 49 to the under-root channel 102a of the first blade 47. As such, cooling fluids from supply channel 100 may be supplied to the under-root channel 102a of the first blade 47 (as is illustrated by arrow 112) via connection channel 106 and under-root channel 102b of the second blade 49. Furthermore, the cooling fluids may also be supplied to, for example, the suction side cooling system 86 of the first blade 47.

The under-root channels 102 of the first and second blades 46 may further include dividers 104 which may divide the under-root channels 102 into two portions (such as a forward (or upstream) portion and an aft (or downstream) portion, for example), and which may prevent fluid communication between the two portions. That is, the dividers 104 may prevent fluid communication between cooling fluids supplied by supply channel 98 (e.g., higher pressure cooling fluids) to the first portion of the under-root channels 102 and cooling fluids supplied by supply channel 100 (e.g., lower pressure cooling fluids) to the second portion of the under-root channels 102. Additionally, although supply channels 98 and 100 are illustrated as being attached to and in fluid communication with different under-root channels 102, the supply channels 98 and 100 may be attached to and in fluid communication with the same under-root channel (such as either under-root channel 102a of the first blade 47 or under-root channel 102b of the second blade 49).

FIG. 7 illustrates another example of fluid communication between airfoils of a turbine engine 10. As shown in FIG. 7, a first airfoil (such as a first blade 47, which is not expressly illustrated in FIGS. 6-8) may be in fluid communication with an under-root channel 102a and a second airfoil (such as a second blade 49, which is not expressly illustrated in FIGS. 6-8) may also be in fluid communication with an under-root channel 102b. Under-root channel 102a of the first blade 47 may be attached to and in fluid communication with supply channel 98. As such, cooling fluids from, for example, first cooling fluid supply system 56 (and portion 62) may be received by the under-root channel 102a of the first blade 47 and supplied to, for example, pressure side cooling system 84 of the first blade 47. Furthermore, a connection channel 108 (which may be formed by the cover plate, for example) may be positioned adjacent to both the under-root channel 102a of the first blade 47 and the under-root channel 102b of the second blade 49, connecting the under-root channel 102a of the first blade 47 to the under-root channel 102b of the second blade 49. As such, cooling fluids from supply channel 98 may be supplied to the under-root channel 102b of the second blade 49 (as is illustrated by arrow 110) via connection channel 108 and under-root channel 102a of the first blade 47. Furthermore, the cooling fluids may also be supplied to, for example, the pressure side cooling system 84 of the first blade 47.

Additionally, the under-root channel 102b of the second blade 49 may be attached to and in fluid communication with supply channel 100. As such, cooling fluids from, for example, cooling fluid supply system 58 (and portion 64) may be received by the under-root channel 102b of the second blade 49 and supplied to, for example, suction side cooling system 86 of the first blade 47. Furthermore, a connection channel 106 may be positioned adjacent to both the under-root channel 102b of the second blade 49 and the under-root channel 102a of the first blade 47, connecting the under-root channel 102b of the second blade 49 to the under-root channel 102a of the first blade 47. As such, cooling fluids from supply channel 100 may be supplied to the under-root channel 102a of the first blade 47 (as is illustrated by arrow 112) via connection channel 106 and under-root channel 102b of the second blade 49. Furthermore, the cooling fluids may also be supplied to, for example, the suction side cooling system 86 of the first blade 47.

The under-root channels 102 of the first and second blades 46 may further include dividers 104 which may divide the under-root channels 102 into two portions (such as a forward (or upstream) portion and an aft (or downstream) portion, for example), and which may prevent fluid communication between the two portions. That is, the dividers 104 may prevent fluid communication between cooling fluids supplied by supply channel 98 (e.g., higher pressure cooling fluids) to the first portion of the under-root channels 102 and cooling fluids supplied by supply channel 100 (e.g., lower pressure cooling fluids) to the second portion of the under-root channels 102. Additionally, although supply channels 98 and 100 are illustrated as being attached to and in fluid communication with different under-root channels 102, the supply channels 98 and 100 may be attached to and in fluid communication with the same under-root channel (such as either under-root channel 102a of the first blade 47 or under-root channel 102b of the second blade 49).

FIG. 8 illustrates a further example of fluid communication between airfoils of a turbine engine 10. As shown in FIG. 8, a first airfoil (such as a first blade 47, which is not expressly illustrated in FIGS. 6-8) may be in fluid communication with an under-root channel 102a and a second airfoil (such as a second blade 49, which is not expressly illustrated in FIGS. 6-8) may also be in fluid communication with an under-root channel 102b. Furthermore, a connection channel 108 may be positioned in-between (or adjacent to) both the under-root channel 102a of the first blade 47 and the under-root channel 102b of the second blade 49. The connection channel 108 may be attached to each of supply channel 98, under-root channel 102a of the first blade 47, and under-root channel 102b of the second blade 49. As such, cooling fluids from supply channel 98 may be supplied to the connection channel 108, and may be further supplied from the connection channel 108 to the under-root channel 102a of the first blade 47 and from the connection channel 108 to the under-root channel 102b of the second blade 49 (as is illustrated by arrows 110). Furthermore, the cooling fluids may also be supplied to, for example, the pressure side cooling system 84 of the first blade 47 and the pressure side cooling system 84 of the second blade 49. As such, cooling fluids from, for example, first cooling fluid supply system 56 (and portion 62) may be received by the under-root channels 102 of the first blade 47 and the second blade 49 (via connection channel 108) and supplied to, for example, the pressure side cooling systems 84 of the first blade 47 and the second blade 49.

Additionally, a connection channel 106 may be positioned in-between (or adjacent to) both the under-root channel 102a of the first blade 47 and the under-root channel 102b of the second blade 49. The connection channel 106 may be attached to each of supply channel 100, under-root channel 102a of the first blade 47, and under-root channel 102b of the second blade 49. As such, cooling fluids from supply channel 100 may be supplied to the connection channel 106, and may be further supplied from the connection channel 106 to the under-root channel 102a of the first blade 47 and from the connection channel 106 to the under-root channel 102b of the second blade 49 (as is illustrated by arrows 112). Furthermore, the cooling fluids may also be supplied to, for example, the suction side cooling system 86 of the first blade 47 and the suction side cooling system 86 of the second blade 49. As such, cooling fluids from, for example, cooling fluid supply system 58 (and portion 64) may be received by the under-root channels 102 of the first blade 47 and the second blade 49 (via connection channel 106) and supplied to, for example, the suction side cooling systems 86 of the first blade 47 and the second blade 49.

The under-root channels 102 of the first and second blades 46 may further include dividers 104 which may divide the under-root channels 102 into two portions (such as a forward (or upstream) portion and an aft (or downstream) portion, for example), and which may prevent fluid communication between the two portions. That is, the dividers 104 may prevent fluid communication between cooling fluids supplied by supply channel 98 (e.g., higher pressure cooling fluids) to the first portion of the under-root channels 102 and cooling fluids supplied by supply channel 100 (e.g., lower pressure cooling fluids) to the second portion of the under-root channels 102.

Although the fluid communication examples of FIGS. 4-8 have been described above with regard to supplying cooling fluids at different pressures (or from different portions of compressor 12) to the airfoils, in particular embodiments, the fluid communication examples of FIGS. 4-8 may be utilized to supply cooling fluids at the same pressure (or from the same portion of compressor 12) to the airfoils. Furthermore, in particular embodiments, cooling fluids having different pressures may be mixed together before being supplied to the airfoils. In such embodiments, the under-root channels 102 and connection channels 106 and 108 may reduce the number of supply channels formed in a rotating disc 48 (or other support structure) of the turbine engine 10, thereby increasing the integrity of the rotating disc 48 (or the other support structure) and/or decreasing the cost of producing the rotating disc 48 (or other support structure).

Furthermore, although the fluid communication examples of FIGS. 4-8 have been described above with regard to turbine blades 46, in particular embodiments, the fluid communication examples of FIGS. 4-8 may be utilized with other airfoils, such as turbine vanes 44. In other embodiments, turbine vanes 44 may receive cooling fluid by a different manner of fluid communication than turbine vanes 46. For example, the turbine engine support structure (such as the inner cylinder 42, or vane carrier) to which the vanes 44 are attached (and/or the turbine shroud support, ring segment support, and/or blade outer air seal support) may include one or more cooling fluid supply systems (such as cooling fluid supply systems 56b, 58b, and 60b of FIG. 1) and one or more pressure cavities (such as one or more pressure cavities 101, 103, and 105 of FIG. 1). Furthermore, the vanes 44 may be in fluid communication with one or more of the pressure cavities 101, 103, and 105 of FIG. 1 via one or more supply channels (similar to supply channels 98 and 100), which may directly (or indirectly) provide cooling fluids to each of the vanes 44 (such as to a pressure side cooling system 84 of each vane 44 and a suction side cooling system 86 of each vane 44, respectively).

The foregoing is provided for purposes of illustrating, explaining, and describing embodiments of this invention. Modifications and adaptations to these embodiments will be apparent to those skilled in the art and may be made without departing from the scope or spirit of this invention

1. A turbine engine comprising:
a rotor assembly having a first row of airfoils arranged circumferentially around the rotor assembly;
a compressor positioned upstream from the rotor assembly;
a first cooling fluid supply system in fluid communication with a first portion of the compressor, the first cooling fluid supply system configured to supply cooling fluids at a first pressure from the first portion of the compressor to a first airfoil of the first row of airfoils; and
a second cooling fluid supply system in fluid communication with a second portion of the compressor, the second cooling fluid supply system configured to supply cooling fluids at a second pressure from the second portion of the compressor to the first airfoil of the first row of airfoils, wherein the second pressure is lower than the first pressure.

2. The turbine engine of claim 1, wherein:
the first cooling fluid supply system is further configured to supply the cooling fluids at the first pressure from the first portion of the compressor to each airfoil of the first row of airfoils; and
the second cooling fluid supply system is further configured to supply the cooling fluids at the second pressure from the second portion of the compressor to each airfoil of the first row of airfoils.

3. The turbine engine of claim 1, wherein the first row of airfoils comprise a first circumferentially aligned row of turbine blades extending radially outward from the rotor assembly.

4. The turbine engine of claim 1, wherein the first row of airfoils comprise a first row of turbine vanes attached to a vane carrier arranged circumferentially around at least a portion of the rotor assembly, wherein the turbine vanes of the first row of turbine vanes each extend radially inward.

5. The turbine engine of claim 1, further comprising:
a second row of airfoils arranged circumferentially around the rotor assembly;
a third cooling fluid supply system in fluid communication with a third portion of the compressor, the third cooling fluid supply system configured to supply cooling fluids at a third pressure from the third portion of the compressor to a first airfoil of the second row of airfoils, wherein the third pressure is lower than the second pressure; and
wherein the second cooling fluid supply system is further configured to supply cooling fluids at the second pressure from the second portion of the compressor to the first airfoil of the second row of airfoils.

6. The turbine engine of claim 5, wherein:
the first row of airfoils comprise a first circumferentially aligned row of turbine blades extending radially outward from the rotor assembly; and
the second row of airfoils comprise a second circumferentially aligned row of turbine blades extending radially outward from the rotor assembly.

7. The turbine engine of claim 5, wherein:
the first row of airfoils comprise a first row of turbine vanes attached to a vane carrier arranged circumferentially around at least a portion of the rotor assembly, wherein the turbine vanes of the first row of turbine vanes each extend radially inward; and
the second row of airfoils comprise a first circumferentially aligned row of turbine blades extending radially outward from the rotor assembly.

8. The turbine engine of claim 5, further comprising a third row of airfoils arranged circumferentially around the rotor assembly; and
wherein the third cooling fluid supply system is further configured to supply cooling fluids at the third pressure from the third portion of the compressor to a first airfoil of the third row of airfoils.

9. The turbine engine of claim 5, further comprising:
a third row of airfoils arranged circumferentially around the rotor assembly; and
a fourth cooling fluid supply system in fluid communication with a fourth portion of the compressor, the fourth cooling fluid supply system configured to supply cooling fluids at a fourth pressure from the fourth portion of the compressor to a first airfoil of the third row of airfoils, wherein the fourth pressure is lower than the third pressure; and
wherein the third cooling fluid supply system is further configured to supply cooling fluids at the third pressure from the third portion of the compressor to the first airfoil of the third row of airfoils.

10. The turbine engine of claim 1, wherein
the first airfoil of the first row of airfoils comprises a pressure side cooling system, a suction side cooling system, and one or more chord-wise ribs positioned in-between the pressure side cooling system and the suction side cooling system;
the first cooling fluid supply system is further configured to supply cooling fluids at the first pressure from the first portion of the compressor to the pressure side cooling system of the first airfoil of the first row of airfoils; and
the second cooling fluid supply system is further configured to supply cooling fluids at the second pressure from the second portion of the compressor to the suction side cooling system of the first airfoil of the first row of airfoils.

11. The turbine engine of claim 5, wherein:
the first airfoil of the first row of airfoils comprises a pressure side cooling system, a suction side cooling system, and one or more chord-wise ribs positioned in-between the pressure side cooling system and the suction side cooling system;
the first airfoil of the second row of airfoils comprises a pressure side cooling system, a suction side cooling system, and one or more chord-wise ribs positioned in-between the pressure side cooling system and the suction side cooling system;
the first cooling fluid supply system is further configured to supply cooling fluids at the first pressure from the first portion of the compressor to the pressure side cooling system of the first airfoil of the first row of airfoils;
the second cooling fluid supply system is further configured to supply cooling fluids at the second pressure from the second portion of the compressor to the suction side cooling system of the first airfoil of the first row of airfoils, and further configured to supply cooling fluids at the second pressure from the second portion of the compressor to the pressure side cooling system of the first airfoil of the second row of airfoils; and
the third cooling fluid supply system is further configured to supply cooling fluids at the third pressure from the third portion of the compressor to the suction side cooling system of the first airfoil of the second row of airfoils.
